(19) United States
(12) Patent Application Publication
(10) Pub. No.: US 2021/0072554 A1
(43) Pub. Date: Mar. 11, 2021

(54) OPTICAL IMAGE STABILIZATION ASSEMBLY

(71) Applicant: AAC Optics Solutions Pte. Ltd., Singapore city (SG)

(72) Inventors: Linzhen Li, Shenzhen (CN); Jiliang Lu, Shenzhen (CN); Gang Li, Shenzhen (CN); Jin Zhang, Shenzhen (CN)

(21) Appl. No.: 16/989,927

(22) Filed: Aug. 11, 2020

(30) Foreign Application Priority Data
Sep. 11, 2019 (CN) 201910860826.8

(51) Int. Cl. G02B 27/64; G02B 7/02

(52) U.S. Cl. CPC G02B 27/642; G02B 7/022

(57) ABSTRACT

The present invention discloses an optical image stabilization assembly including a ring-shaped first base, a second base arranged inside the first base and spaced therefrom, and three shape memory alloy wires. Each shape memory alloy wires includes a first fixing end fixed to the first base, a first extending section extending from the first fixing end toward the second base, a second fixing end fixed to the second base, a second extending section extending from the second fixing end toward the first base and a third fixing end connected to the second extending section and fixed to the first base. An angle between two driving forces applied respectively by two adjacent shape memory alloy wires accessing to electricity to the second base is less than 180°, and reverse extension lines of the driving forces applied by the shape memory alloy wires extend to gather at one point.

### TECHNICAL FIELD

The present disclosure relates to the technical field of lens optical imaging, in particular to an optical image stabilization assembly.

### BACKGROUND

In recent years, portable terminals such as smart phones and tablet computers are equipped with lens modules of high performance. The lens module of high performance generally has an auto focusing (AF) function and an optical image stabilization (OIS) function. The lens module of high performance moves the lens in the direction of the optical axis of the lens during autofocus, and moves the lens in the direction perpendicular to the optical axis of the lens when implementing the optical image stabilization function. Since shape memory alloys (SMA) has the best shape memory performance among shape memory materials at present, SMA wires are widely used in the field of optical image stabilization.

In order to realize the stabilization function, the existing lens module usually needs to be provided with four SMA wires, and both ends of the four SMA wires are respectively fixed on the four sides. The four SMA wires can generate four driving forces at different directions, and the lens can be driven to move arbitrarily in the plane perpendicular to the optical axis by adjusting the magnitude relationship between these four forces, thereby achieving the stabilization function. However, providing four SMA wires not only makes the lens module structure relatively complicated, but also increases the production cost accordingly.

Therefore, it is necessary to develop an optical image stabilization assembly that can overcome the above problems.

### SUMMARY

The present disclosure intends to provide an optical image stabilization assembly, which has the advantages of simple structure and reduced production cost.

The purpose of the present disclosure is achieved by the following technical solutions.

An optical image stabilization assembly for optical image stabilization of a lens is provided, including a ring-shaped first base, a second base for lens installation arranged inside the first base and spaced from the first base, and three shape memory alloy wires configured to drive the second base to move in a direction perpendicular to an optical axis of the lens. Each of the shape memory alloy wires includes a first fixing end fixed to the first base, a first extending section extending from the first fixing end toward the second base, a second fixing end fixed to the second base, a second extending section extending from the second fixing end toward the first base, and a third fixing end connected to the second extending section and fixed to the first base. The first fixing end and the third fixing ends are arranged separately, and the first extending section extends away from an end of the first fixing end to be fixed to the second fixing end. An angle between the two driving forces applied by two adjacent shape memory alloy wires accessing to electricity to the second base is less than 180°, and reverse extension lines of the driving forces applied by the shape memory alloy wires extend to gather at one point.

As an improvement, the three shape memory alloy wires are defined as a first shape memory alloy wire, a second shape memory alloy wire and a third shape memory alloy wire, respectively. The first base includes a first side plate, a second side plate arranged opposite to and spaced from the first side plate, a third side plate and a fourth side plate which are connected between the first side plate and the second side plate and are spaced from each other. The first fixing end and the third fixing end of the first shape memory alloy wire are fixed to the first side plate separately, the first fixing end of the second shape memory alloy wire is fixed to the second side plate, the third fixing end of the second shape memory alloy wire is fixed to the third side plate, the first fixing end of the third shape memory alloy wire is fixed to the second side plate, and the third fixing end of the third shape memory alloy wire is fixed to the fourth side plate.

As an improvement, the three shape memory alloy wires are defined as a first shape memory alloy wire, a second shape memory alloy wire and a third shape memory alloy wire, respectively. The first base includes a first side plate, a second side plate arranged opposite to and spaced from the first side plate, a third side plate and a fourth side plate which are connected between the first side plate and the second side plate and are spaced from each other. The first fixing end and the third fixing end of the first shape memory alloy wire are fixed to the first side plate separately, the first fixing end of the second shape memory alloy wire is fixed to the second side plate, the third fixing end of the second shape memory alloy wire is fixed to the third side plate, and the first fixing end and the third fixing end of the third shape memory alloy wire are fixed to the fourth side plate separately.

As an improvement, the optical image stabilization assembly further includes three convex posts protruding from the second base and provided around the optical axis at intervals, and each of the convex posts is correspondingly connected to the second fixing end of one of the shape memory alloy wires.

As an improvement, the optical image stabilization assembly further includes a blocking piece provided on the convex post to prevent the second fixing end from being detached from the convex post.

As an improvement, the optical image stabilization assembly further includes a plurality of connectors fixed to the first base, and each of the first fixing end and the third fixing end is electrically connected to one of the connectors.

As an improvement, the first base is provided with a plurality of mounting posts protruding therefrom, and each of the connectors defines a through hole matching with one of the mounting post.

As an improvement, the first base is further provided with a plurality of grooves recessing therefrom, the mounting posts are provided in the grooves, respectively, and the connectors are embedded in the grooves, respectively.

As an improvement, the connector includes a fixing portion configured to electrically connect to the first fixing end or the third fixing end, a conducting portion configured to connect to an external power supply and a bending portion connecting the conducting portion and the fixing portion, and the bending portion extends from the conducting portion in an s-shape to the fixing portion.

As an improvement, the groove includes a first groove portion and a second groove portion communicating with the first groove portion, the fixing portion is embedded in the first groove portion, and the conducting portion is embedded in the second groove portion.

Compared with the existing technology, the embodiments of the present disclosure include three shape memory alloy wires, each of which includes a first fixing end, a first extending section, a second fixing end, a second extending section, and a third fixing end, the first fixing end and the third fixing end are connected to the first base, the second fixing end is connected to the second base. The angle between the driving forces applied by the two adjacent shape memory alloy wires to the second base is less than 180°, and the reverse extension lines of the three driving forces applied by the three shape memory alloy wires extend to gather at the point. By adjusting the magnitude relationship between the three driving forces, the second base may be driven to move in any direction perpendicular to the optical axis. The optical image stabilization assembly provided in the embodiments only needs three shape memory alloy wires to realize the stabilization function, resulting in simpler structure and reduced production cost.

### BRIEF DESCRIPTION OF THE DRAWINGS

FIG. 1 is a schematic structural diagram of an optical image stabilization assembly provided by Embodiment 1 of the present disclosure;

FIG. 2 is a partially exploded view of an optical image stabilization assembly provided by Embodiment 1 of the present disclosure;

FIG. 3 is a schematic structural diagram of FIG. 1 from another angle;

FIG. 4 is a schematic structural diagram of the shape memory alloy wire shown in FIG. 1;

FIG. 5 is a schematic structural diagram of the first base shown in FIG. 2;

FIG. 6 is a schematic diagram of the assembly of the second base and the convex post shown in FIG. 2;

FIG. 7 is a schematic structural diagram of the connector shown in FIG. 2;

FIG. 8 is a schematic structural diagram of an optical image stabilization assembly provided by Embodiment 2 of the present disclosure.

### DETAILED DESCRIPTION

The present disclosure will be further described below with reference to the accompanying drawings and embodiments.

It should be noted that all the directional indications (such as upper, lower, left, right, front, back, inside, outside, top, bottom, etc.) in the embodiments of the present disclosure are only used to explain the relative positional relationship and the like between the various components in a certain posture (as shown in the figures). If the specific posture changes, the directional indications will also change accordingly.

It should also be noted that when an element is referred to as being “fixed” or “provided” on another element, the element may be directly on the other element or there may be an intermediate element therebetween. When an element is referred to as “connecting with” another element, the element may directly connects with the other element or there may be an intermediate element therebetween.

### Embodiment 1

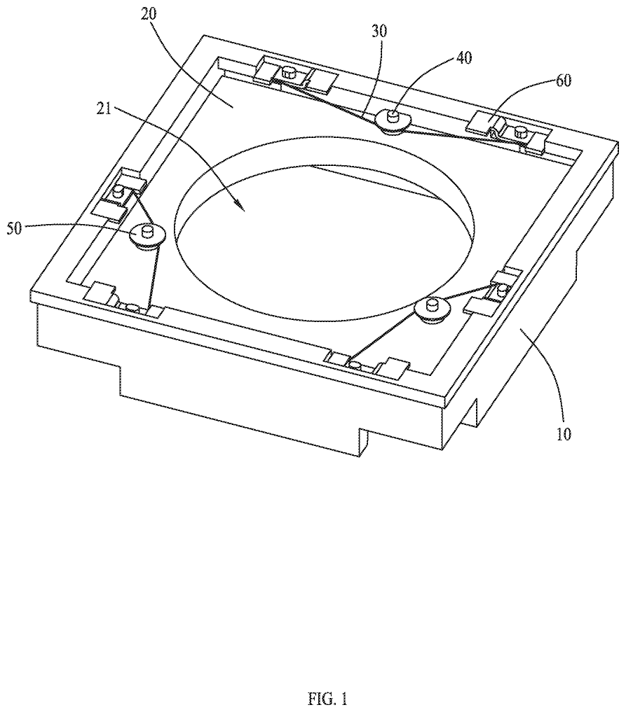

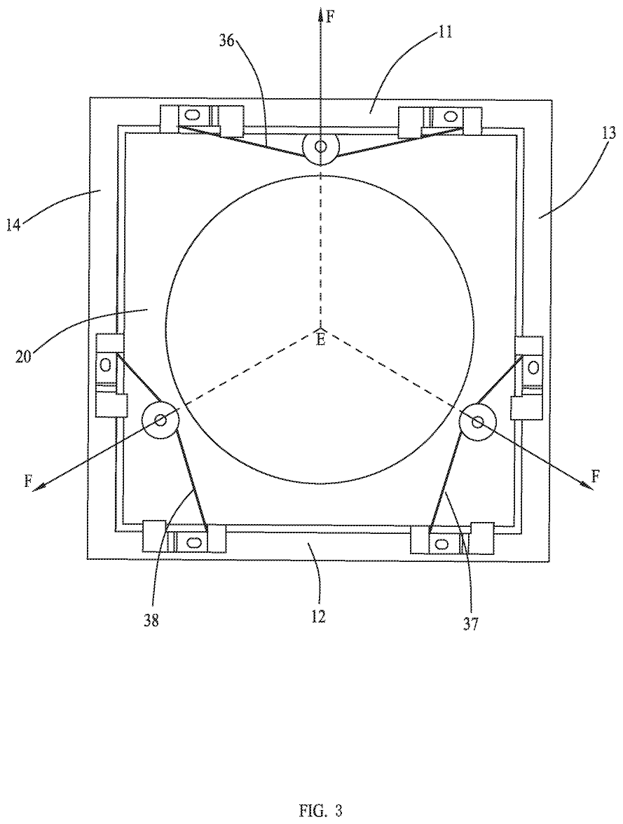

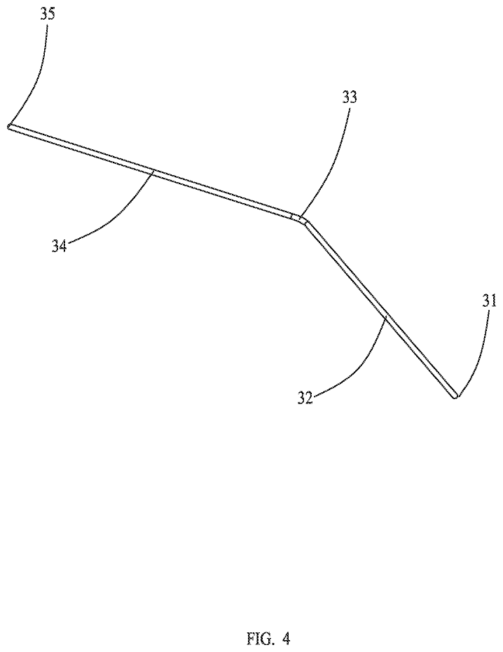

Referring to FIGS. 1-4, Embodiment 1 of the present disclosure provides an optical image stabilization assembly 100, including a first base 10, a second base 20, and three shape memory alloy wires 30. The first base 10 has a ring shape, the second base 20 is provided inside the first base 10 and spaced therefrom, and the second base 20 defines a mounting hole 21 for lens installation. Each shape memory alloy wire 30 includes a first fixing end 31 fixed on the first base 10, a first extending section 32 extending from the first fixing end 31 toward the second base 20, and a second fixing end 33 fixed on the second base 20, a second extending section 34 extending from the second fixing end 33 toward the first base 10, and a third fixing end 35 connected to the second extending section 34 and fixed on the first base 10. The first fixing end 31 and the third fixing end 35 are arranged separately, the first extending section 32 extends away from the end of the first fixing end 31 to be fixed to the second fixing end 33, that is, each shape memory alloy wire 30 is configured in a V-shape. The three shape memory alloy wires 30 are provided around an optical axis S of the lens at intervals. Two adjacent shape memory alloy wires 30, when accessing to electricity, apply two driving forces F to the second base 20, respectively, an angle between the two driving forces F is less than 180°. Reverse extension lines of the driving forces applied by the three shape memory alloy wires 30 extend to gather at one point E.

When the three shape memory alloy wires 30 do not access to electricity, the second base 20 is located at an original position inside the first base 10, and meanwhile the three shape memory alloy wires 30 are in a relaxed state. When the lens is offset in a direction perpendicular to the optical axis S due to shakes, that is, the second base 20 is offset relative to the first base 10 in the direction perpendicular to the optical axis S, a current is passed into the corresponding shape memory alloy wire 30 and the shape memory alloy wire 30 is heated to shrink. The shape memory alloy wire 30 may apply a driving force F perpendicular to the optical axis S to the second base 20 and drives the second base 20 to move in a direction of the driving force F, such that the second base 20 together with the lens moves back to the initial position, thereby achieving the stabilization effect.

In this embodiment, the angle between the driving forces F applied by the two adjacent shape memory alloy wires 30 is less than 180°, and the reverse extension lines of the driving forces F applied by the shape memory alloy wires 30 extend to gather at the point E. Therefore, by adjusting the magnitude relationship between the three driving forces, the second base 20 may be driven to move in any direction perpendicular to the optical axis S. Compared with the conventional stabilization lens which needs four shape memory alloy wires, the optical image stabilization assembly 100 in the embodiment only needs three shape memory alloy wires 30 to realize the stabilization function, resulting in simpler structure and reduced production cost.

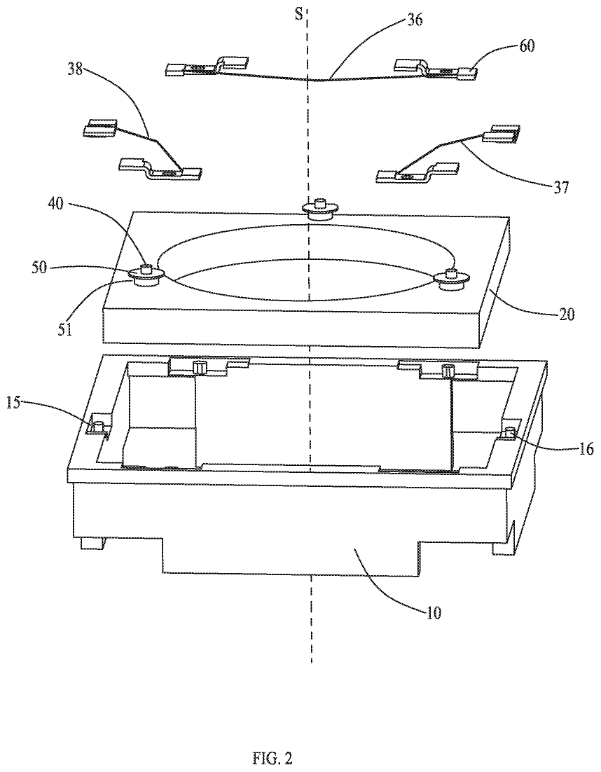

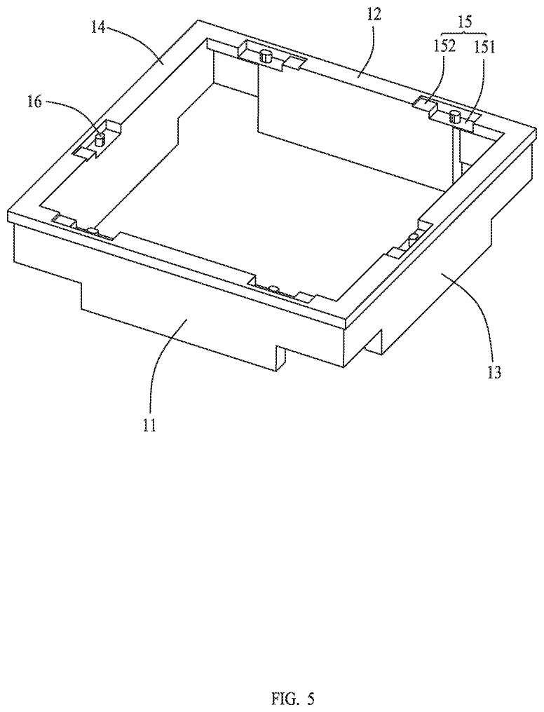

Referring to FIG. 2 and FIG. 5, as an improvement of this embodiment, the first base 10 is surrounded by four side plates, and the four side plates are defined as a first side plate 11, a second side plate 12, a third side plate 13 and a fourth side plate 14, respectively. The first side plate 11 and the second side plate 12 are arranged in parallel and spaced from each other, and the third side plate 13 and the fourth side plate 14 are arranged in parallel and spaced from each other. The third side plate 13 and the fourth side plate 14 are arranged between the first side plate 11 and the second side plate 12 and connected to both ends of the first side plate 11 and the second side plate 12. The three shape memory alloy wires 30 are defined as a first shape memory alloy wire 36, a second shape memory alloy wire 37, and a third shape memory alloy wire 38. The first fixing end 31 and the third fixing end 35 of the first shape memory alloy wire 36 are fixed to the first side plate 11 separately. The first fixing end 31 of the second shape memory alloy wire 37 is fixed on the second side plate 12, and the third fixing end 35 of the second shape memory alloy wire 37 is fixed to the third side plate 13. The first fixing end 31 of the third shape memory alloy wire 38 is fixed to the second side plate 12, and the third fixing end 35 of the third shape memory alloy wire 38 is fixed to the fourth side plate 14.

In this embodiment, the initial length of the first shape memory alloy wire 36 is 7.9 mm. When the first shape memory alloy wire 36 shrinks and thus drives the second base 20 to move by 0.15 mm, the length of the first shape memory alloy wire 36 after shrinking is 7.84 mm, with a strain rate of about 0.76%. The initial length of each of the second shape memory alloy wire 37 and the third shape memory alloy wire 38 is 5.56 mm. When the second shape memory alloy wire 37 or the third shape memory alloy wire 38 shrinks and thus drives the second base 20 to move 0.15 mm, the length of the second shape memory alloy wire 37 or the third shape memory alloy wire 38 after shrinking is 5.53 mm, with a strain rate of about 0.54%.

It should be appreciated that the first base 10 is not limited to being provided with four side plates. For example, the first base 10 may also be designed in a circular ring shape, as long as the three shape memory alloy wires 30 are provided around the optical axis S at intervals, and the second base 20 may be driven to move in any direction perpendicular to the optical axis S by adjusting the magnitude relationship between the three driving forces.

Referring to FIG. 2, as an improvement of this embodiment, the optical image stabilization assembly 100 further includes three convex posts 40, three blocking pieces 50, and six connectors 60. Each of the first side plate 11 and the second side plate 12 of the first base 10 is provided with two connectors 60 spaced from each other. Each of the third side plate 13 and the fourth side board 14 is provided with one connector 60. The three convex posts 40 are fixed on the second base 20 and arranged around the optical axis S at intervals. A blocking piece 50 is fixed on each convex post 40, the first fixing end 31 and the third fixing end 35 of each shape memory alloy wire 30 are fixed to the first base 10 through the connectors 60, and the second fixing end 33 of each shape memory alloy wire 30 is fixed to the second base 20 through the convex post 40. Preferably, the second fixing end 33 may be fixed to the convex post 40 by means of adhesive.

It should be appreciated that the shape memory alloy wire 30 is not limited to being indirectly fixed to the first base 10 and the second base 20. For example, the shape memory alloy wire 30 may also be directly fixed to the first base 10 and the second base 20 in other mechanical fixing manners, as long as the shape memory alloy wire 30 can drive the second base 20 to move in the direction perpendicular to the optical axis S when accessing to electricity.

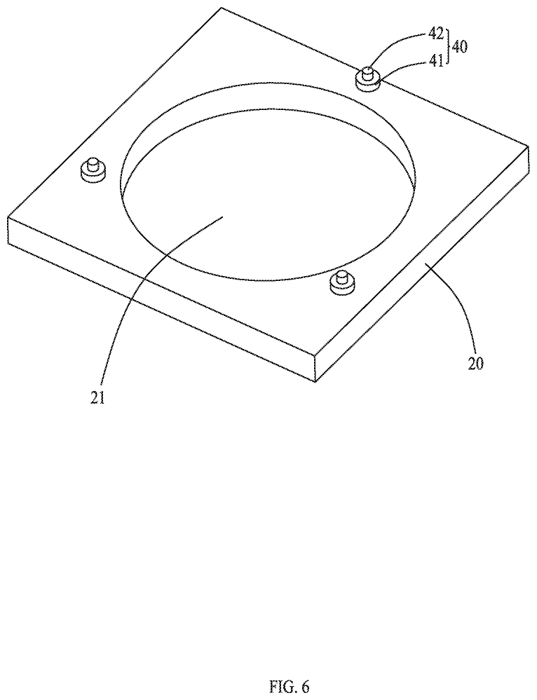

Referring to FIG. 2 and FIG. 6, as an improvement of this embodiment, the convex post 40 includes a first extending portion 41 and a second extending portion 42. The first extending portion 41 and the second extending portion 42 are both cylindrical. The diameter of the first extension portion 41 is larger than that of the second extension portion 42. The first extending portion 41 is fixed on the second base 20, the second extending portion 42 protrudes from a side of the first extending portion 41 away from the second base 20. The blocking piece 50 is fixed on the second extending portion 42. An annular flute 51 is defined by the blocking piece 50, the first extending portion 41 and the second base 20, and the second fixing end 33 is fixed on a side of the annular flute 51 closer to the optical axis S.

In this embodiment, the blocking piece 50 provided on the second extending portion 42 effectively prevents the shape memory alloy wire 30 from being detached from the convex post 40, and also enhances the fixation of the shape memory alloy wire 30 in the optical axis S direction. Besides, the second fixing end 33 itself of the shape memory alloy wire 30 is not further fixed by such fixation. Operation of one of the shape memory alloy wires 30 would not additionally increase the stress of the other two lines 30, which prolongs service life of the shape memory alloy wires 30.

It should be appreciated that, the convex post 40 is not limited to the above-mentioned configuration. For example, it is also possible that the diameter of the first extending portion 41 is smaller than that of the second extending portion 42, or the convex post 40 is designed as a cylinder.

Referring to FIG. 2 and FIG. 5, as an improvement of this embodiment, the first base 10 defines a groove 15 for mounting the connector 60. Each of the first side plate 11 and the second side plate 12 is provided with two grooves 15 spaced from each other, and each of the third side plate 13 and the fourth side plate 14 is provided with one groove 15. Each groove 15 is provided with a mounting post 16 protruding therefrom, and each connector 60 is disposed within the groove 15 and defines a through hole 61 for allowing the mounting post 16 to pass through.

In this embodiment, it contributes to miniaturization and compactness of the overall structure of the optical image stabilization assembly 100 with the overall height of the optical image stabilization assembly 100 reduced by disposing the connector 60 within the groove 15.

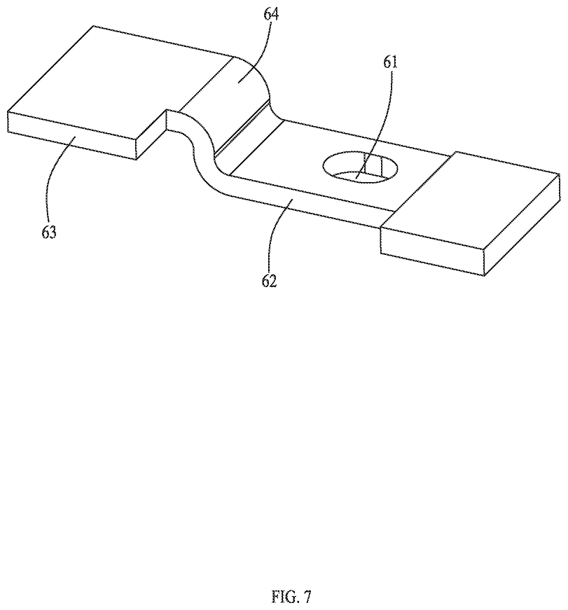

Referring to FIG. 5 and FIG. 7, as an improvement of this embodiment, the groove 15 includes a first groove portion 151 and a second groove portion 152, and the mounting post 16 is provided in the first groove portion 151. The connector 60 includes a fixing portion 62, a conducting portion 63, and a bending portion 64, and the through hole 61 is defined on the fixing portion 62. The fixing portion 62 is embedded in the first groove portion 151, and the first fixing end 31 and the third fixing end 35 of the shape memory alloy wire 30 are both fixed to the fixing portion 62. The conducting portion 63 is embedded in the second groove portion 152, and is used to couple to an external power source, that is, to be welded to a circuit board. The bending portion 64 has an S-shape, and extends from the conducting portion 63 to the fixing portion 62, so that there is a difference in height between the conducting portion 63 and the fixing portion 62, thereby facilitating the welding of the conducting portion 63 to the circuit board.

### Example 2

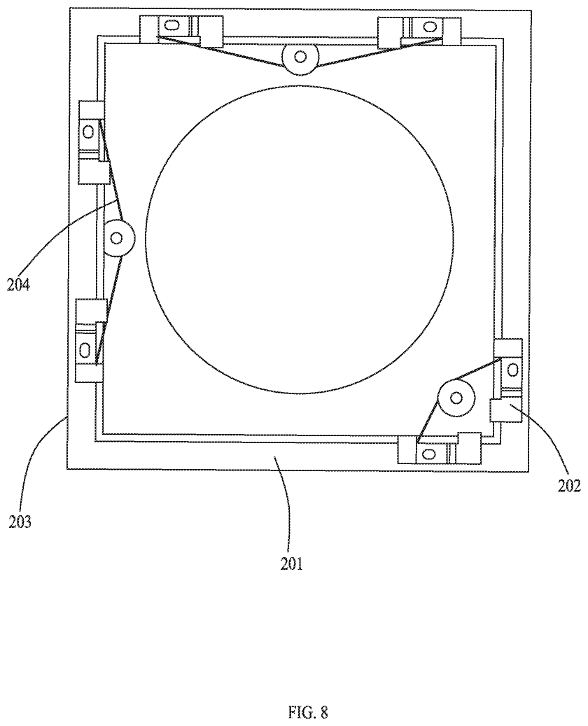

Referring to FIG. 8, an optical image stabilization assembly 200 is provided in this embodiment which is different from the optical image stabilization assembly 100 provided in embodiment 1 mainly in the arrangement of the three shape memory alloy wires. Specifically, in this embodiment, the second side plate 201 is provided with only one connector 202, while the fourth side plate 203 is provided with two connectors 202, and the first fixing end and the third fixing end of the third shape memory alloy wire 204 are fixed to the two connectors 202 on the fourth side plate 203, respectively.

The above-described are merely embodiments of the present disclosure. It should be noted that those of ordinary skill in the art can make improvements without departing from the inventive concept of the present disclosure, such improvements, however, fall within the protection scope of the present disclosure.

What is claimed is:

1. An optical image stabilization assembly for optical image stabilization of a lens comprising a ring-shaped first base, a second base for lens installation arranged inside the first base and spaced from the first base, and three shape memory alloy wires configured to drive the second base to move in a direction perpendicular to an optical axis of the lens, wherein each of the shape memory alloy wires comprises a first fixing end fixed to the first base, a first extending section extending from the first fixing end toward the second base, a second fixing end fixed to the second base, a second extending section extending from the second fixing end toward the first base, and a third fixing end connected to the second extending section and fixed to the first base, the first fixing end and the third fixing ends are arranged separately, the first extending section extends away from an end of the first fixing end to be fixed to the second fixing end, an angle between two driving forces applied respectively by two adjacent shape memory alloy wires accessing to electricity to the second base is less than 180°, and reverse extension lines of the driving forces applied by the shape memory alloy wires extend to gather at one point.

2. The optical image stabilization assembly according to claim 1, wherein the three shape memory alloy wires are defined as a first shape memory alloy wire, a second shape memory alloy wire and a third shape memory alloy wire, respectively, the first base comprises a first side plate, a second side plate arranged opposite to and spaced from the first side plate, a third side plate and a fourth side plate which are connected between the first side plate and the second side plate and are spaced from each other, the first fixing end and the third fixing end of the first shape memory alloy wire are fixed to the first side plate separately, the first fixing end of the second shape memory alloy wire is fixed to the second side plate, the third fixing end of the second shape memory alloy wire is fixed to the third side plate, the first fixing end of the third shape memory alloy wire is fixed to the second side plate, and the third fixing end of the third shape memory alloy wire is fixed to the fourth side plate.

3. The optical image stabilization assembly according to claim 1, wherein the three shape memory alloy wires are defined as a first shape memory alloy wire, a second shape memory alloy wire and a third shape memory alloy wire, respectively, the first base comprises a first side plate, a second side plate arranged opposite to and spaced from the first side plate, a third side plate and a fourth side plate which are connected between the first side plate and the second side plate and are spaced from each other, the first fixing end and the third fixing end of the first shape memory alloy wire are fixed to the first side plate separately, the first fixing end of the second shape memory alloy wire is fixed to the second side plate, the third fixing end of the second shape memory alloy wire is fixed to the third side plate, and the first fixing end and the third fixing end of the third shape memory alloy wire are fixed to the fourth side plate separately.

4. The optical image stabilization assembly according to claim 1, further comprising three convex posts protruding from the second base and provided around the optical axis at intervals, and each of the convex posts is correspondingly connected to the second fixing end of one of the shape memory alloy wires.

5. The optical image stabilization assembly according to claim 4, further comprising a blocking piece provided on each of the convex posts to prevent the second fixing end from being detached from the convex post.

6. The optical image stabilization assembly according to claim 1, further comprising a plurality of connectors fixed to the first base, and each of the first fixing end and the third fixing end is electrically connected to one of the connectors.

7. The optical image stabilization assembly according to claim 6, wherein the first base is provided with a plurality of mounting posts protruding therefrom, and each of the connectors defines a through hole matching with one of the mounting post.

8. The optical image stabilization assembly according to claim 7, wherein the first base is further provided with a plurality of grooves recessing therefrom, the mounting posts are provided in the grooves, respectively, and the connectors are embedded in the grooves, respectively.

9. The optical image stabilization assembly according to claim 8, wherein the connector comprises a fixing portion configured to electrically connect to the first fixing end or the third fixing end, a conducting portion configured to connect to an external power supply and a bending portion connecting the conducting portion and the fixing portion, and the bending portion extends from the conducting portion in an s-shape to the fixing portion.

10. The optical image stabilization assembly according to claim 9, wherein the groove comprises a first groove portion and a second groove portion communicating with the first groove portion, the fixing portion is embedded in the first groove portion, and the conducting portion is embedded in the second groove portion.
